(19) United States
(12) Patent Application Publication
(10) Pub. No.: US 2010/0073268 A1
(43) Pub. Date: Mar. 25, 2010

(54) ORGANIC ELECTROLUMINESCENT DISPLAY DEVICE AND PATTERNING METHOD

(76) Inventors: Atsushi Matsunaga, Kanagawa (JP); Masaya Nakayama, Kanagawa (JP); Atsushi Tanaka, Kanagawa (JP)

Correspondence Address: BIRCH STEWART KOLASCH & BIRCH, PO BOX 747, FALLS CHURCH, VA, 22040-0747, US

(21) Appl. No.: 12/594,541

(22) PCT Filed: Apr. 3, 2008
(86) PCT No.: PCT/JP2008/057053

§ 371 Date: Oct. 2, 2009

(30) Foreign Application Priority Data
Apr. 5, 2007 (JP) 2007-099516

(51) Int. Cl. G09G 3/30; H01J 9/00

(52) U.S. Cl. 345/76; 445/24

(57) ABSTRACT

An organic electroluminescent display device includes a driving TFT and pixels which are formed by organic electroluminescent elements and provided in a pattern on a substrate of the TFT. The driving TFT includes at least a substrate, a gate electrode, a gate insulating film, an active layer, a source electrode, and a drain electrode; the driving TFT further includes a resistive layer between the active layer and at least one of the source electrode and the drain electrode; and the pixels are formed in a pattern by a laser transfer method. A patterning method by a laser transfer method for producing the fine pixels is also provided.

### TECHNICAL FIELD

The present invention relates to an organic electroluminescent display device having an organic electroluminescent element and a TFT (thin film transistor), in particular to an organic electroluminescent display device having a TFT in which an improved amorphous oxide semiconductor is used. The invention further relates to a patterning method for forming high definition pixels in the organic electroluminescent display device. In the present invention, the TFT refers to a field-effect TFT unless otherwise indicated.

### BACKGROUND ART

In recent years, flat thin image-display devices (flat panel displays: FPD) have been put into practical use along with advance in technology in liquid crystal and electroluminescence. In particular, organic electroluminescent elements (hereinafter referred to as “organic El elements” in some cases), which use thin-layer materials that are excited by electric current to emit light, can emit light of high luminance with a low voltage, and are expected to realize reduction in the thickness, weight, size, and power consumption of the devices in wide range of fields, including cell phone displays, personal digital assistants (PDA), computer displays, information displays to be mounted on automobiles, TV monitors, and general illumination.

These FPDs are driven by active matrix circuits of TFTs, in which an amorphous silicon thin film or a polycrystalline silicon thin film provided on a glass substrate is used as an active layer.

There is another attempt to use a light-weighted flexible resin substrate in place of the glass substrate, for the purposes of further reducing the thickness and the weight of the FPDs and further improving the breakage resistance thereof.

However, since the production of the TFTs in which the silicon thin film is used requires a thermal treatment at a relatively high temperature, it is difficult to directly form the silicon thin film on the resin substrate, which generally has poor heat resistance.

Therefore the development of TFTs having semiconductor thin films made of amorphous oxides (e.g., In—Ga—Zn—O type amorphous oxide) capable of film formation at low temperature, has been conducted actively (see, for example, Japanese Patent Application Laid-Open (JP-A) No. 2006-165529.

The amorphous oxide semiconductors as materials for the active layers of film (flexible) TFTs have attracted attention since the amorphous oxide semiconductors are capable of film formation at room temperature and thus are able to be formed on films. In particular, it has been reported by Hosono et al. of Tokyo Institute of Technology that TFTs using a-IGZO achieved a field-effect mobility of about 10 cm²/Vs even on a PEN substrate, which was higher than the mobility achieved by a-Si type TFTs on glass substrates; thus the TFTs using a-IGZO have attracted attention as film TFTs in particular (see, for example, Nature vol. 432 (25 Nov., 2004) pp. 488-492).

From an aspect, improvement in the definition of FPDs has been desired. In order to achieve a higher definition, it has been necessary to make the size of TFTs minute, as well as to make the pixels of organic EL elements finer.

A laser transfer method has been disclosed as a means for forming fine pixels (see, for example, U.S. Pat. No. 5,998,085 and JP-A No. 2003-168569). However, although an organic EL element driven by an electric current needs to be controlled to maintain a constant current even if the pixels are made small, the electric current value decreases with reduction of the size in conventional TFTs and thus it has been difficult to cope with the reduction of the pixel size by using conventional TFTs.

When the TFTs using a-IGZO are used as driving circuits of display devices for example, there are problems in that the mobility of 1 to 10 cm²/Vs is insufficient for supplying an adequate electric current, the OFF current is large, and ON/OFF ratio is low. Therefore further improvements in the mobility and the ON/OFF ratio have been required for driving an organic EL elements.

### DISCLOSURE OF THE INVENTION

### Problem to be Solved by the Invention

An object of the present invention is to provide an organic electroluminescent display device (hereinafter referred to as “organic EL display device” in some cases) equipped with a TFT in which an amorphous oxide semiconductor with a high field-effect mobility and a high ON/OFF ratio is used, in particular a high performance organic EL display device that can be formed on a flexible resin substrate. Another object of the present invention is to provide a patterning method for forming fine pixels of the organic EL display device, the method employing a laser transfer method.

### Means to Solve the Problem

The above objects of the present invention are achieved by the following measures:

A first aspect of the present invention provides an organic electroluminescent display device comprising at least a driving thin film transistor (TFT) and pixels which are formed by organic electroluminescent elements and are provided in a pattern on a substrate of the TFT, wherein the driving TFT includes at least a substrate, a gate electrode, a gate insulating film, an active layer, a source electrode, and a drain electrode; the driving TFT further includes a resistive layer between the active layer and at least one of the source electrode and the drain electrode; and the pixels are formed in a pattern by a laser transfer method.

A second aspect of the invention provides an organic electroluminescent display device as described in the first aspect, wherein the resistive layer has a lower electrical conductivity than that of the active layer.

A third aspect of the invention provides an organic electroluminescent display device as described in the first or second aspect, wherein the active layer is in contact with the gate insulating film, and the resistive layer is in contact with at least one of the source electrode and the drain electrode.

A fourth aspect of the invention provides an organic electroluminescent display device as described in any one of the first to third aspects, wherein the thickness of the resistive layer is greater than the thickness of the active layer.

A fifth aspect of the invention provides an organic electroluminescent display device as described in any one of the first to third aspects, wherein electrical conductivity continuously varies between the resistive layer and the active layer.

A sixth aspect of the invention provides an organic electroluminescent display device as described in any one of the first to fifth aspects, wherein the active layer and the resistive layer include oxide semiconductors, which may be the same or different.

A seventh aspect of the invention provides an organic electroluminescent display device as described in the sixth aspect, wherein the oxide semiconductor is an amorphous oxide semiconductor.

An eighth aspect of the invention provides an organic electroluminescent display device as described in the sixth or seventh aspect, wherein the oxygen concentration in the active layer is lower than the oxygen concentration in the resistive layer.

A ninth aspect of the invention provides an organic electroluminescent display device as described in any one of the sixth to eighth aspects, wherein the oxide semiconductor is at least one oxide selected from the group consisting of In, Ga, and Zn, or a composite oxide thereof.

A tenth aspect of the invention provides an organic electroluminescent display device as described in the ninth aspect, wherein the oxide semiconductor includes In and Zn, and the composition ratio of Zn to In (Zn/In) in the resistive layer is higher than that in the active layer.

An eleventh aspect of the invention provides an organic electroluminescent display device as described in any one of the first to tenth aspects, wherein the electrical conductivity of the active layer is 10⁻⁴ Scm⁻¹ or more but less than 10² Scm⁻¹.

A twelfth aspect of the invention provides an organic electroluminescent display device as described in any one of the first to eleventh aspects, wherein the ratio of the electrical conductivity of the active layer to the electrical conductivity of the resistive layer (electrical conductivity of the active layer/electrical conductivity of the resistive layer) is from 10² to 10⁸.

A thirteenth aspect of the invention provides an organic electroluminescent display device as described in any one of the first to twelfth aspects, wherein the substrate is a flexible resin substrate.

A fourteenth aspect of the invention provides an organic electroluminescent display device as described in any one of the first to thirteenth aspects, wherein the pixels has a definition of 200 ppi or more.

A fifteenth aspect of the invention provides an organic electroluminescent display device patterning method of patterning pixels formed by organic electroluminescent elements on a substrate of a driving transistor, the method comprising:

forming a donor sheet containing at least a layer that absorbs an electromagnetic wave and converts it to heat, and forming a transfer layer containing an organic electroluminescent material on the donor sheet;

bringing the transfer layer side of the donor sheet into contact with a pixel-forming surface of the substrate; and

selectively irradiating the donor sheet with a laser so as to thermally melt the transfer layer and so as to transfer the organic electroluminescent material onto the substrate, wherein the driving TFT includes at least a substrate, a gate electrode, a gate insulating film, an active layer, a source electrode, and a drain electrode; the driving TFT further includes a resistive layer between the active layer and at least one of the source electrode and the drain electrode.

A sixteenth aspect of the invention provides an organic electroluminescent display device patterning method as described in the fifteenth aspect, wherein the pixels have a definition of 200 ppi or more.

TFTs using amorphous oxide semiconductors as materials for the active layers of film (flexible) TFTs have attracted attention because they are capable of film formation at room temperature and they can be produced using flexible plastic films as substrates. In particular, a TFT formed on PET has been reported which achieves a field-effect mobility of 10 cm²/Vs and an ON/OFF ratio above 10³ by the use of an In—Ga—Zn—O type oxide in a semiconductor layer (active layer), as disclosed in JP-A No. 2006-165529. However, when the TFT is used as a driving TFT of an organic EL display device for example, the performance thereof has been insufficient in respect of the mobility and the ON/OFF ratio. The reason is that it has conventionally been difficult to form a TFT that achieves both of a superior OFF characteristics and a high mobility since the electron mobility decreases when a measure to lower the electron carrier concentration in the active layer is taken for the purpose of reducing the OFF electric current.

Further, there have been demands for a higher definition, finer pixels together with smaller-sized TFTs, improved ON/OFF characteristics, a higher mobility, and ability to apply a high electric current, in the field of organic EL display devices.

The inventors of the present invention have made an earnest effort to find a measure to heighten the field-effect mobility of the TFT and improve the ON/OFF ratio thereof. As a result, the inventors have found that the problems can be solved by a TFT with a configuration that has at least a gate electrode, a gate insulating film, an active layer, a source electrode and a drain electrode wherein the TFT further includes a resistive layer between the active layer and at least one of the source electrode and the drain electrode. In particular, it has been found effective to adopt a configuration in which at least an active layer that is in contact with the gate insulating film and a resistive layer that is in contact with at least one of the source electrode and the drain electrode are provided and in which the electrical conductivity of the active layer is higher than the electrical conductivity of the resistive layer.

The inventors have further found that a combination of the above-described TFT and patterning of an organic EL material by a laser transfer method as a measure to make fine pixels is most preferable, thus arrived at the present invention. Therefore, the present disclosure describes an organic EL display device according to the present invention and a method of patterning the organic EL display device by a laser transfer method.

### EFFECTS OF THE INVENTION

According to the present invention, an organic EL display device can be provided having a TFT in which an amorphous oxide semiconductor with a high field-effect mobility, a high ON/OFF ratio, and capability to control a high electric current is used. In particular, a high performance organic EL display device that can be formed on a flexible resin substrate can be provided. Moreover, a patterning method of forming fine pixels in the organic EL display device by a laser transfer method is also provided.

### BRIEF DESCRIPTION OF THE DRAWINGS

FIG. 1 is a conceptual diagram showing a structure of a driving TFT 100 and an organic EL element 10 in an organic EL display device according to the present invention.

FIG. 2 is a schematic circuit diagram of a switching TFT, a driving TFT, and a main part of an organic EL element in an organic EL display device according to the present invention.

FIG. 3 is a conceptual diagram showing a structure of a donor sheet in a laser transfer method.

FIG. 4 is a conceptual diagram showing a structure of a TFT according to the present invention.

FIG. 5 is a conceptual diagram showing a structure of a top-gate type TFT according to the present invention.

### BEST MODE FOR CARRYING OUT THE INVENTION

### 1. Thin Film Transistor (TFT)

The TFT according to the invention is an active element including at least a gate electrode, a gate insulating film, an active layer, a source electrode, and a drain electrode in this order, and having a function of applying a voltage to the gate electrode so as to control the electric current flowing into the active layer and so as to switch the electric current between the source electrode and the drain electrode. The TFT structure may be either a staggered structure or an inversely-staggered structure.

In the present invention, a resistive layer is disposed between, and electrically connects, the active layer and at least one of the source electrode or the drain electrode. The electrical conductivity of the resistive layer is preferably lower than the electrical conductivity of the active layer.

In a preferable exemplary embodiment, at least the resistive layer and the active layer are provided, in layers, on the substrate, the resistive layer is in contact with the gate insulating film, and the active layer is in contact with at least one of the source electrode and the drain electrode.

The electrical conductivity of the active layer is preferably 10⁻⁴Scm⁻¹ or more but less than 10²Scm⁻¹, more preferably 10⁻¹Scm⁻¹ or more but less than 10²Scm⁻¹. The electrical conductivity of the resistive layer is preferably 10⁻²Scm⁻¹ or less, more preferably from 10⁻⁹Scm⁻¹ or more but less than 10⁻³Scm⁻¹, and is lower than the electrical conductivity of the active layer. More preferably, the ratio of the electrical conductivity of the active layer to the electrical conductivity of the resistive layer (the electrical conductivity of the active layer/the electrical conductivity of the resistive layer) is in the range of from 10² to 10⁸.

A high field-effect mobility may not be obtained when the electrical conductivity of the active layer is lower than 10⁻⁴Scm⁻¹, whereas an excellent ON/OFF ratio may not be obtained when the electrical conductivity of the active layer is 10²Scm⁻¹ or more due to an increase in the OFF current, which is not preferable.

The thickness of the resistive layer is preferably greater than the thickness of the active layer, from the viewpoint of operation stability.

More preferably, the ratio of the thickness of the resistive layer to the thickness of the active layer (the thickness of the resistive layer/the thickness of the active layer) is more than 1 but 100 or less, and is still more preferably more than 1 but 10 or less.

It is also preferable that electrical conductivity continuously varies between the resistive layer and the active layer in the active layer.

Preferably, the active layer and/or the resistive layer includes an oxide semiconductor from the viewpoint of capability of low-temperature film formation. In particular, the oxide semiconductor is more preferably in an amorphous state. When the active layer and the resistive layer both include oxide semiconductors, the oxide semiconductors may be the same or different.

The oxygen concentration in the active layer is preferably lower than the oxygen concentration of the resistive layer.

The oxide semiconductor preferably includes at least one selected from the group consisting of In, Ga, and Zn, or a composite oxide thereof. The oxide semiconductor more preferably includes In and Zn, and the composition ratio of Zn to In (Zn/In) in the resistive layer is preferably higher than that in the active layer. The composition ratio of Zn to In (Zn/In) in the resistive layer is preferably higher than that in the active layer by at least 3%, and more preferably, by at least 10%.

The substrate is preferably a flexible resin substrate.

1) Structure

Next, a structure of a TFT used in the present invention will be described.

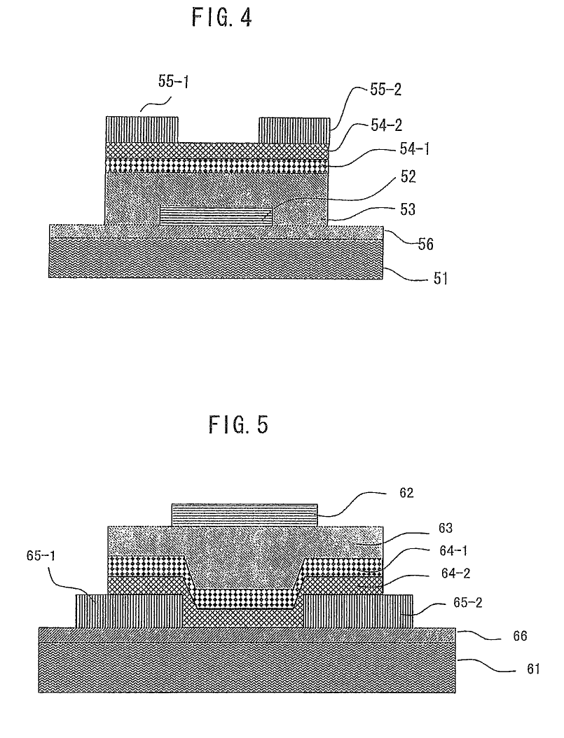

FIG. 4 is a schematic diagram showing an example of a TFT with an inversely staggered structure according to the present invention. When a substrate 51 is a flexible substrate such as a plastic film, an insulating layer 56 is provided on one surface of the substrate 51, and a gate electrode 52, a gate insulating film 53, a active layer 54-1, a resistive layer 54-2 are layered thereon, and a source electrode 55-1 and a drain electrode 55-2 are further provided on a surface of the resistive layer. The active layer 54-1 is in contact with the gate insulating film 53, and the resistive layer 54-2 is in contact with the source electrode 55-1 and the drain electrode 55-2. The compositions of the active layer and the resistive layer are determined such that the electrical conductivity of the active layer is higher than the electrical conductivity of the resistive layer when a voltage is not applied to the gate electrode. The active layer and the resistive layer include oxide semiconductors selected from those disclosed in JP-A No. 2006-165529; for example, an In—Ga—Zn—O oxide semiconductor. These oxide semiconductors are known to show increased electron mobility as the electron carrier concentration increases. In other words, higher electrical conductivity leads to higher electron mobility.

In the structure according to the present invention, a high ON electric current is realized when the TFT is in an ON-state following application of a voltage to the gate electrode to form a channel; this is because the field-effect mobility of the TFT is high due to a high electrical conductivity of the active layer which is serving as the channel. In the OFF-state in which a voltage is not applied to the gate electrode and the channel is not formed, the ON/OFF ratio characteristics are significantly improved by the presence of the intervening resistive layer having a high electrical resistance which maintains the OFF current at a low level.

The TFT structure according to the present invention features a semiconductor layer in which the electrical conductivity of the semiconductor layer in the vicinity of the gate insulating film is higher than the electrical conductivity of the semiconductor layer in the vicinity of the source electrode and the drain electrode. The term “semiconductor layer” used herein refers to a layer including the active layer and the resistive layer. As long as this configuration is achieved, the means for achieving it are not limited to e.g. providing a semiconductor layer having two layers as shown in FIG. 4. The structure may have a multi-layer structure having three or more layers, or the electrical conductivity may vary continuously therein.

FIG. 5 is a schematic diagram showing an example of a TFT having a top gate structure according to the present invention. When a substrate 61 is a flexible substrate such as a plastic film, an insulating layer 66 is provided on one surface of the substrate 61, a source electrode 65-1 and a drain electrode 65-2 are provided on the insulating layer, a resistive layer 64-2 and a active layer 64-1 are further layered thereon, and a gate insulating film 63 and a gate electrode 62 are further provided thereon. Similarly to the inversely staggered structure, the active layer (high electrical conductivity layer) is in contact with the gate insulating film 63, and the resistive layer (low electrical conductivity layer) is in contact with the source electrode 65-1 and the drain electrode 65-2. The compositions of the active layer 64-1 and the resistive layer 64-2 are determined such that the electrical conductivity of the active layer 64-1 is higher than the electrical conductivity of the resistive layer 64-2 when a voltage is not applied to the gate electrode 62.

2) Electrical Conductivity

The electrical conductivity of the active layer and the resistive layer according to the invention will be described.

An electrical conductivity is a characteristic value that indicates easiness of electric conduction through a substance, and is represented by the following formula:

σ=neμ

wherein n represents the carrier concentration of the substance, μ represents the carrier mobility, σ represents the electrical conductivity of the substance, and e represents the elementary electric charge. When the active layer or the resistive layer is a n-type semiconductor, the carrier is electrons, the carrier concentration refers to the electron carrier concentration, and the carrier mobility refers to the electron mobility. Similarly, when the active layer or the resistive layer is a p-type semiconductor, the carrier is holes, the carrier concentration refers to the hole carrier concentration, and the carrier mobility refers to the hole mobility. The carrier concentration and the carrier mobility of a substance can be obtained by a measurement of holes.

### <Method for Obtaining Electrical Conductivity>

By measuring the sheet resistance of a film whose thickness has already been determined, the electrical conductivity of the film can be obtained. Although the electrical conductivity of the semiconductor varies with temperature, the electrical conductivity mentioned herein refers to an electrical conductivity at room temperature (20° C.).

3) Gate Insulating Film

The gate insulating film may include an insulating substance such as SiO₂, SiNₓ, SiON, Al₂O₃, Y_{S}O₃, Ta₂O₅, or HfO₂, or a mixed crystal compound containing at least two selected from these compounds. A macromolecular insulating material such as polyimide may also be used as the gate insulating film

The thickness of the gate insulating film is preferably from 10 nm to 10 μm. The gate insulating film should have a substantial thickness in order to reduce a leak current and increase voltage resistance. However, an increase in the thickness of the gate insulating film results in an increase in the TFT driving voltage. Therefore, the thickness of the gate insulating film is more preferably from 50 nm to 1000 nm in the case of an inorganic insulating material, and is more preferably from 0.5 μm to 5 μm in the case of a macromolecular insulating material. In particular, when an insulating material with a high dielectric constant, such as HfO₂, is used in the gate insulating layer, TFT may be driven at low voltage even with an increased film thickness, which is preferable.

4) Active Layer and Resistive Layer

The active layer and the resistive layer to be used in the invention preferably include oxide semiconductors. The oxide semiconductors are more preferably amorphous oxide semiconductors. Oxide semiconductors, in particular amorphous oxide semiconductors, can be formed on a flexible resin substrate such as plastic, due to its ability to form a film at low temperature. Preferable examples of amorphous oxide semiconductors that can be formed at low temperature include oxides each containing In, oxides each containing In and Zn, and oxides each containing In, Ga, and Zn, as described in JP-A No. 2006-165529. It is known that the composition structure thereof is preferably InGaO₃(ZnO)ₘ wherein m represents a natural number less than 6. These oxides are n-type semiconductors in which the carrier is electrons. Of course, the active layer and the resistive layer may alternatively include p-type oxide semiconductors, such as ZnO—Rh₂O₃, CuGaO₂, or SrCu₂O₂.

Specifically, the amorphous oxide semiconductor according to the invention is preferably an amorphous oxide semiconductor including In—Ga—Zn—O and having a composition of InGaO₃(ZnO)ₘ (m representing a natural number less than 6) in the crystalline state. In particular, InGaZnO₄ is more preferable. An amorphous oxide semiconductor having the composition characteristically has a tendency to show an increased electron mobility as the electrical conductivity increases. It has been disclosed in JP-A No. 2006-165529 that the electrical conductivity can be adjusted by adjusting an oxygen partial pressure during film formation.

Of course, the materials of the active layer and the resistive layer are not limited to oxide semiconductors, and inorganic semiconductors such as Si and Ge, compound semiconductors such as GaAs, and organic semiconductors such as pentacene and polythiophene are also usable in the active layer and/or the resistive layer.

<Electrical Conductivity of Active Layer and Resistive Layer>

The electrical conductivity of the active layer according to the invention is characteristically higher than that of the resistive layer.

The ratio of the electrical conductivity of the active layer to the electrical conductivity of the resistive layer (the electrical conductivity of the active layer/the electrical conductivity of the resistive layer) is preferably from 10¹ to 10¹⁰, more preferably from 10² to 10⁸. The electrical conductivity of the active layer is preferably from 10⁻⁴Scm⁻¹ or more but less than 10²Scm⁻¹, more preferably from 10⁻¹Scm⁻¹ or more but less than 10²Scm⁻¹.

The electrical conductivity of the resistive layer is preferably 10⁻²Scm⁻¹ or less, and more preferably from 10⁻⁹Scm⁻¹ to 10⁻³Scm⁻¹.

<Thicknesses of Active Layer and Resistive Layer>

The thickness of the resistive layer is preferably greater than the thickness of the active layer. It is more preferable that the ratio of the thickness of the resistive layer to the thickness of the active layer is more than 1 but 100 or less, and it is still more preferable that the ratio is more than 1 but 10 or less.

The thickness of the active layer is preferably from 1 nm to 100 nm, and more preferably from 2.5 nm to 30 nm. The thickness of the resistive layer is preferably from 5 nm to 500 nm, and more preferably from 10 nm to 100 nm.

A TFT characteristics with an ON/OFF ratio of 10⁶ or more can be achieved in a TFT having a high mobility of 10 cm²/(Vsec) by using an active layer and a resistive layer having the above constitutions.

<Methods for Adjusting Electrical Conductivity>

The following measures may be mentioned as methods for adjusting electrical conductivity when the active layer and the resistive layer are oxide semiconductors.

### (1) Adjustment by Oxygen Defects

It is known that, when oxygen defects occur in an oxide semiconductor, carrier electrons are generated to increase the electrical conductivity. Therefore it is possible to adjust the electrical conductivity of the oxide semiconductor by adjusting the amount of oxygen defects. Specific methods for adjusting the oxygen defects amount may include adjustment of at least one of the oxygen partial pressure during film formation, the oxygen concentration during a post-treatment after film formation and the processing time of the post-treatment. Examples of the post-treatment include, specifically, a thermal treatment at 100° C. or higher, an oxygen plasma, and a UV ozone treatment. Among these methods, a method of adjusting the oxygen partial pressure during film formation is preferable from the viewpoint of productivity. JP-A No. 2006-165529 discloses that the electrical conductivity of an oxide semiconductor can be adjusted by adjusting the oxygen partial pressure during film formation, and this technique may be utilized.

### (2) Adjustment by Composition Ratio

It has been known that the electrical conductivity can be changed by changing the metal composition ratio of an oxide semiconductor. For example, it is disclosed in JP-A No. 2006-165529 that an increased proportion of Mg in InGaZn₁₋ₓMgₓO₄ leads to a decrease in electrical conductivity. Further, it has been reported that, in an oxide system of (In₂O₃)₁₋ₓ(ZnO)ₓ, an increase in Zn proportion leads to a decrease in electrical conductivity if the Zn/In ratio is in the range of 10% or higher (see “Toumei Doudennmakuno Shintennkai II” (New Development of transparent conductive film) (CMC Publishing Co., Ltd.) pp. 34 to 35). A specific method for changing the composition ratio may be, for example in a film formation by sputtering, use of a target selected from various targets of different composition ratios. Alternatively, multiple targets may be co-sputtered, and the sputtering rates of the targets may be individually controlled to change the composition ratio of the film.

### (3) Adjustment by Impurity

It is disclosed in JP-A No. 2006-165529 that the electron carrier concentration can be reduced (i.e., the electrical conductivity can be reduced) by adding to an oxide semiconductor one or more elements such as Li, Na, Mn, Ni, Pd, Cu, Cd, C, N, or P as impurity. Examples of methods for adding the impurity include co-deposition of the oxide semiconductor and the impurity element(s), and an ion doping method of doping a produced oxide semiconductor film with ions of the impurity element(s).

### (4) Adjustment by Oxide Semiconductor Material

In the above items (1) to (3), methods for adjusting electrical conductivity within the same oxide semiconductor series are described. However, as a matter of course, the electrical conductivity can be changed also by changing the oxide semiconductor material. For example, SnO₂-based oxide semiconductors are known to generally have a lower electrical conductivity than In₂O₃-based oxide semiconductors. Accordingly, the electrical conductivity can be adjusted by changing the oxide semiconductor material. As oxide materials having particularly small electrical conductivities, oxide insulating materials such as Al₂O₃, Ga₂O₃, ZrO₂, Y₂O₃, Ta₂O₃, MgO, or HfO₃ are known, and are usable in the invention.

For adjusting the electrical conductivity, only one of the methods described in (1) to (4) may be used singly, or a combination of some or all of the methods described in (1) to (4) may be used.

<Method for Forming Active Layer and Resistive Layer>

Methods for forming the active layer and the resistive layer are preferably vapor-phase film forming methods using polycrystalline sintered bodies of oxide semiconductors as targets. Among vapor-phase film forming methods, a sputtering method and a pulse laser deposition method (PLD method) are suitable. Further, the sputtering method is preferable from the viewpoint of mass production.

For example, a film can be formed by an RF magnetron sputtering deposition method under controlled vacuum degree and oxygen flow rate. A lower electrical conductivity can be obtained at a larger oxygen flow rate.

The film that has been formed can be confirmed to be an amorphous film by a well-known X-ray diffraction method. The thickness of the film can be determined by a measurement with a stylus-type surface profilometer. The composition ratio can be obtained by a RBS (Rutherford back scattering) analysis method.

### 5) Gate Electrode

The gate electrode in the present invention is preferably, for example, a metal such as Al, Mo, Cr, Ta, Ti, Au, or Ag, an alloy such as Al—Nd or APC, a metal oxide conductor film such as tin oxide, zinc oxide, indium oxide, indium tin oxide (ITO), or an indium zinc oxide (IZO), an organic conductive compound such as polyaniline, polythiophene, or polypyrrole, or a mixture thereof.

The thickness of the gate electrode is preferably from 10 nm to 1000 nm

Methods for forming an electrode film are not particularly limited, and the electrode may be formed on the substrate by a method selected appropriately from, for example, wet methods such as printing methods and coating methods, physical methods such as vacuum deposition methods, sputtering methods, and ion plating methods, and chemical methods such as CVD and plasma CVD methods, in consideration of compatibility with the aforementioned material. For example, when ITO is selected, an electrode can be provided by, for example, a DC or radio-frequency sputtering method, a vacuum deposition method, or an ion plating method. When an organic conductive compound is selected as the material for the gate electrode, an electrode can be formed by a wet-system film forming method.

### 6) Source Electrode and Drain Electrode

Materials for the source electrode and the drain electrode in the invention are preferably selected from, for example, metals such as Al, Mo, Cr, Ta, Ti, Au, and Ag, alloys such as Al—Nd and APC, metal oxide conductive films such as of tin oxide, zinc oxide, indium oxide, indium tin oxide (ITO), and indium zinc oxide (IZO), organic conductive compounds such as polyaniline, polythiophene and polypyrrole, and mixtures thereof.

The thicknesses of the source electrode and the drain electrode are each preferably within the range of from 10 nm to 1000 nm.

Methods for forming an electrode film are not particularly limited, and the electrode may be formed on the substrate by a method selected appropriately from, for example, wet methods such as printing methods and coating methods, physical methods such as vacuum deposition methods, sputtering methods, and ion plating methods, and chemical methods such as CVD and plasma CVD methods, in consideration of compatibility with the aforementioned material. For example, when ITO is selected, an electrode can be provided by, for example, a DC or radio-frequency sputtering method, a vacuum deposition method, or an ion plating method. When an organic conductive compound is selected as the material for the source electrode and the drain electrode, an electrode can be formed by a wet-system film forming method.

### 7) Substrate

The substrate to be used in the present invention is not particularly limited, and examples thereof include inorganic materials such as YSZ (yttria-stabilized zirconia) and glass, and organic materials such as polyesters (e.g., polyethylene terephthalate, polybutylene terephthalate, and polyethylene naphthalate) and synthetic resins (e.g., polystyrene, polycarbonate, polyethersulfone, polyarylate, allyldiglycolcarbonate, polyimide, polycycloolefin, norbornene resins, and poly(chlorotrifluoroethylene). When the substrate includes an organic material selected from the above, the organic material is preferably excellent in heat resistance, dimensional stability, solvent resistance, electric insulating property, and processability, and preferably low in gas permeation and hygroscopicity.

In the present invention, a flexible substrate is preferably used in particular. As materials to be used in the flexible substrate, organic plastic films having high transparency are preferable, and examples of usable plastic films include plastic films of polyesters such as polyethylene terephthalate, polybutylene phthalate, and polyethylene naphthalate, polystyrene, polycarbonate, polyethersulfone, polyarylate, polyimide, polycycloolefin, norbornene resins, and poly(chlorotrifluoroethylene). The film-shaped plastic substrate is preferably provided with one or more additional layers such as an insulating layer that may be provided when the insulating property of the substrate is insufficient, a gas barrier layer for preventing permeation of moisture and oxygen, and an undercoat layer for improving the planarity of the film-shaped plastic substrate and adhesion to the electrode and/or the active layer.

The thickness of the flexible substrate is preferably from 50 μm to 500 μm. This is because, when the thickness of the flexible substrate is less than 50 μm, it is difficult for the substrate itself to maintain sufficient planarity. When the thickness of the flexible substrate is larger than 500 μm, it is difficult to freely bend the substrate; in other words, the flexibility of the substrate itself is poor.

### 8) Protective Insulating Film

A protective insulating film may be provided on the TFT as necessary. The protective insulating film is used for protecting the semiconductor layer (the active layer and the resistive layer) from deterioration caused by air, and/or for insulating the TFT from an electronic device to be produced on the TFT.

Specific examples of protective insulating film materials include metal oxides such as MgO, SiO, SiO₂, Al₂O₃, GeO, NiO, CaO, BaO, Fe₂O₃, Y₂O₃, and TiO₂, metal nitrides such as SiNₓ and SiNₓO_{y}, metal fluorides such as MgF₂, LiF, AlF₃, and CaF₂, polyethylene, polypropylene, polymethyl methacrylate, polyimide, polyurea, polytetrafluoroethylene, polychlorotrifluoroethylene, polydichlorodifluoroethylene, copolymers of chlorotrifluoroethylene and dichlorodifluoroethylene, copolymers obtained by copolymerization of a mixture of monomers including tetrafluoroethylene and at least one comonomer, fluorine-containing copolymers each having a cyclic structure in the copolymer main chain, water absorbing substances having a water absorption coefficient of 1% or more, and dampproof substances having a water absorption coefficient of 0.1% or less.

Methods for forming the protective insulating film are not particularly limited, and the following methods are applicable: a vacuum deposition method, a sputtering method, a reactive sputtering method, an MBE (molecular beam epitaxy) method, a cluster ion beam method, an ion plating method, a plasma polymerization method (radio-frequency exciting ion plating method), a plasma CVD method, a laser CVD method, a heat CVD method, a gas source CVD method, a coating method, a printing method, and a transfer method.

### 9) Post-Treatment

A thermal treatment may be conducted as a post-treatment on the TFT, as necessary. The thermal treatment may be conducted at a temperature of 100° C. or more in the air or in a nitrogen atmosphere. The thermal treatment may be conducted after forming the semiconductor layer and/or as a final step in the TFT production process. The thermal treatment is effective in, for example, suppression of in-plane unevenness of the TFT characteristics and an improvement of the driving stability. [0034] 2. Organic EL Element

The organic EL element according to the present invention has a cathode and an anode on a substrate, and further has one or more organic compound layers, including an organic luminescent layer (hereinafter simply referred to as “luminescent layer” in some cases), between the electrodes. In view of the characteristics of the luminescent element, at least one electrode selected from the anode and the cathode is preferably transparent.

Regarding the lamination of the organic compound layers in the present invention, an embodiment is preferable in which a hole transport layer, a luminescent layer, and an electron transport layer are provided in this order from the anode side. Further, a charge blocking layer or the like may be provided between the hole transport layer and the luminescent layer, or between the luminescent layer and the electron transport layer. There may be a hole injection layer between the anode and the hole transport layer, and there may be an electron injection layer between the cathode and the electron transport layer. Each layer may include plural sub-layers.

In the following, components constituting the luminescent material according to the present invention will be described in detail.

<Substrate>

The substrate to be used in the present invention is preferably a substrate that does not scatter or attenuate the light emitted from the organic compound layers. Examples thereof include inorganic materials such as yttria-stabilized zirconia and glass, polyesters such as polyethylene terephthalate, polybutylene phthalate, and polyethylene naphthalate, polystyrene, polycarbonate, polyethersulfone, polyarylate, polyimide, polycycloolefin, norbornene resins, and poly(chlorotrifluoroethylene).

For example, when glass is used as the substrate, the glass material is preferably a non-alkaline glass in consideration of reduction of eluted ions from glass. When a soda-lime glass is used, it is preferable to use one which has been barrier-coated with silica or the like. When the substrate is an organic material, the material is preferably excellent in heat resistance, dimensional stability, solvent resistance, electric insulating property, and processability.

The shape, structure, and size of the substrate are not particularly limited, and may be appropriately selected in accordance with the use, purpose, and the like of the luminescent element. In general, the substrate is preferably plate-shaped. The structure of the substrate may be a single-layer structure, or a multi-layer structure, and may be constituted by only one member or by two or more members.

The substrate may be colorless transparent, or colored transparent. However, a colorless transparent substrate is preferable since the light emitted from the organic luminescent layer is not scattered or attenuated.

A moisture blocking layer (gas barrier layer) may be provided on the front or back surface of the substrate. The material of the moisture blocking layer (gas barrier layer) is preferably an inorganic material such as silicon nitride or silicon oxide. The moisture blocking layer (gas barrier layer) may be formed by, for example, a radio-frequency sputtering method.

When a thermoplastic substrate is used, one or more additional layers such as a hardcoat layer or an undercoat layer may be provided in accordance with necessity.

<Anode>

The anode generally has a function as an electrode that supplies holes to an organic compound layer. The shape, structure, and size thereof are not particularly limited, and may be appropriately selected from known electrode materials in accordance with the use and purpose of the luminescent element. As described above, the anode is usually provided as a transparent anode.

The material of the anode is preferably, for example, a metal, an alloy, a metal oxide, a conductive compound, or a mixture thereof. Specific examples of the anode material include conductive metal oxides such as tin oxides doped with antimony, fluorine, or the like (ATO, FTO), tin oxide, zinc oxide, indium oxide, indium tin oxide (ITO), and indium zinc oxide (IZO), metals such as gold, silver, chromium, and nickel, mixtures and laminates of any of such metals and a conductive metal oxide, inorganic conductive materials such as copper iodide and copper sulfide, organic conductive materials such as polyaniline, polythiophene, and polypyrrole, and laminates of any of such materials and ITO. Among them, a conductive metal oxide is preferable, and ITO is more preferable from the viewpoints of, in particular, productivity, high electrical conductivity, and transparency.

The anode may be formed on the substrate by a method that is appropriately selected from, for example, the following methods in consideration of the compatibility with the material for constituting the anode: wet systems such as printing systems and coating systems, physical systems such as vacuum deposition methods, sputtering methods, and ion plating methods, and chemical methods such as CVD and plasma CVD methods. For example, when ITO is selected as the material of the anode, the anode may be formed by a DC or radio-frequency sputtering method, a vacuum deposition method, or an ion plating method.

In the organic electroluminescent element according to the invention, the position at which the anode is provided is not particularly limited, and may be selected appropriately in accordance with the use and purpose of the luminescent element. The anode is preferably formed on the substrate; in this case, the anode may be provided on the whole of one surface of the substrate, or on only a part of the one surface of the substrate.

The patterning at the time of forming the anode may be conducted by a chemical etching such as photolithography, or by a physical etching such as etching with a laser. The patterning may be effected by vacuum deposition, sputtering, or the like with a mask being superposed, or by a lift-off method or a printing method.

The thickness of the anode may be adequately selected in accordance with the material constituting the anode, and thus cannot be defined uniquely. The thickness of the anode is generally from about 10 nm to about 50 μm, preferably from 50 nm to 20 μm.

The electric resistance of the anode is preferably 10³ Ω/sq or less, more preferably 10² Ω/sq or less. When the anode is transparent, the anode may be colorless transparent or colored transparent. In order to extract emitted light from the transparent anode side, the transmittance of the anode is preferably 60% or more, and more preferably 70% or more.

Transparent anodes are described in detail in Yutaka Sawada ed. “Toumei Denkyokumakuno Shintenkai” (New Development of Transparent Electrode Film) (CMC Publishing Co., Ltd., 1999), and the contents thereof can be applied to the present invention. When a plastic substrate with poor heat resistance is used, it is preferable to conduct film formation at a low temperature of 150° C. or lower using ITO or IZO, to form a transparent anode.

<Cathode>

The cathode generally has a function as an electrode that injects electrons into an organic compound layer. The shape, structure, and size thereof are not particularly limited, and may be appropriately selected from known electrode materials in accordance with the use and purpose of the luminescent element.

The material constituting the cathode may be, for example, a metal, an alloy, a metal oxide, a conductive compound, or a mixture thereof. Specific examples of the cathode material include alkali metals (e.g., Li, Na, K, Cs), alkali earth metals (e.g., Mg, Ca), gold, silver, lead, aluminum, a sodium-potassium alloy, a lithium-aluminum alloy, a magnesium-silver alloy, and rare earth metals such as indium and ytterbium. Only one of these materials may be used singly; however, it is preferable to use two or more of such materials in combination, from the viewpoint of obtaining a good balance of stability and electron injection ability.

Among them, as the material constituting the cathode, alkali metals and alkali earth metals are preferable in terms of electron injection ability, and a material whose main component is aluminum is preferable due to its superior storage stability.

The material whose main component is aluminum means aluminum itself, or an alloy or mixture of aluminum and 0.01 to 10 weight % of alkali metal or alkali earth metal (e.g., a lithium-aluminum alloy, a magnesium-aluminum alloy).

Materials for cathodes are described in detail in JP-A Nos. 2-15595 and 5-121172, and the materials described therein can be applied to the present invention.

Methods for forming the cathode are not particularly limited, and the cathode may be formed by known methods. The cathode may be formed by a method selected appropriately from, for example, the following in consideration of the compatibility with the material for constituting the cathode: wet systems such as printing systems and coating systems, physical systems such as vacuum deposition methods, sputtering methods, and ion plating methods, and chemical methods such as CVD and plasma CVD methods. For example, when a metal or the like is selected as the material of the cathode, the cathode may be formed by, for example, sputtering one material or sputtering two or more materials simultaneously or sequentially.

The patterning at the time of forming the cathode may be conducted by a chemical etching such as photolithography, or by a physical etching such as etching with a laser. The patterning may be effected by vacuum deposition, sputtering, or the like with a mask being superposed, or by a lift-off method or a printing method.

In the invention, the position at which the cathode is formed is not particularly limited. For example, the cathode may be formed on an entire surface of an organic compound layer, or on only a part of a surface of the organic compound layer.

A dielectric layer of a fluoride or oxide of an alkali metal or alkali earth metal with a thickness of from 0.1 nm to 5 nm may be inserted between the cathode and the organic compound layer. The dielectric layer may be considered to be a kind of electron injection layer. The dielectric layer can be formed by, for example, a vacuum deposition method, a sputtering method, or an ion plating method.

The thickness of the cathode may be adequately selected in accordance with the material constituting the cathode, and thus cannot be defined uniquely. The thickness of the cathode is generally from about 10 nm to about 5 μm, preferably from 50 nm to 1 μm.

The cathode may be transparent or opaque. A transparent cathode can be formed by forming a thin film of the cathode material to a thickness of from 1 nm to 10 nm, and further depositing a transparent conductive material such as ITO or IZO.

<Organic Compound Layer>

The organic compound layers in the invention will be described.

An organic electroluminescent element according to the invention includes one or more organic compound layers including a luminescent layer. Examples of organic compound layers other than the organic luminescent layer include a hole transport layer, an electron transport layer, a charge blocking layer, a hole injection layer, and an electron injection layer, as described above.

—Organic Luminescent Layer—

The organic luminescent layer is a layer having the following functions at the time of voltage application: receiving holes from the anode, the hole injection layer, or the hole transport layer, receiving electrons from the cathode, the electron injection layer, or the electron transport layer, and providing a site for recombination of the holes and the electrons, thereby emitting light.

The luminescent layer in the invention may be constituted of only a luminescent material, or may be a mixture layer containing a host material and a luminescent material. The luminescent material may be a fluorescent luminescent material or a phosphorescent luminescent material, and may have only one dopant or two or more dopants. The host material is preferably a charge transport material. The luminescent layer may include only one host material or two or more host materials, for example a mixture of an electron transporting host material and a hole transporting host material. The luminescent layer may include a material that does not have electron transporting property and does not emit light.

The luminescent layer may include only one layer, or two or more layers, and the two or more layers may emit lights of respectively different colors.

Examples of fluorescent luminescent materials that can be used in the invention include: metal complexes such as metal complexes of benzoxazole derivatives, benzimidazole derivatives, benzothiazole derivatives, styrylbenzene derivatives, polyphenyl derivatives, diphenylbutadiene derivatives, tetraphenylbutadiene derivatives, naphthalimide derivatives, coumarin derivatives, condensed aromatic compounds, perinone derivatives, oxadiazole derivatives, oxazine derivatives, aldazine derivatives, pyralidine derivatives, cyclopentadiene derivatives, bisstyrylanthracene derivatives, quinacridone derivatives, pyrrolopyridine derivatives, thiadiazolopyridine derivatives, cyclopentadiene derivatives, styrylamine derivatives, diketopyrrolopyrrol derivatives, aromatic dimethylidine compounds, 8-quinolinol derivatives and pyrromethene derivatives; polymer compounds such as polythiophene, polyphenylene, and polyphenylenevinylene; and other compounds such as organic silane derivatives.

Examples of phosphorescence luminescent materials that can be used in the invention include complexes containing transition metal atoms or lanthanoid atoms.

The transition metal atoms are not particularly limited; ruthenium, rhodium, palladium, tungsten, rhenium, osmium, iridium, and platinum are preferable, and rhenium, iridium, and platinum are more preferable.

Examples of the lanthanoid atoms include lanthanum, cerium, praseodymium, neodymium, samarium, europium, gadolinium, terbium, dysprosium, holmium, erbium, thulium, ytterbium, and lutetium. Among these lanthanoid atoms, neodymium, europium, and gadolinium are preferable.

As ligands for the complex, the ligands described in the following literatures can be mentioned as examples: G. Wilkinson et al., Comprehensive Coordination Chemistry (Pergamon Press, 1987), H. Yersin Photochemistry and Photographics of Coordination Compounds (Springer-Verlag, 1987), and Akio Yamamoto, Yuukikinnzoku kagaku-Kisotoouyou-(Organic metal chemistry-Fundamentals and Applications) (Shokabo Publishing Co., Ltd., 1982).

With respect to specific ligands, preferable ones include halogen ligands (preferably chlorine ligands), nitrogen-containing heterocyclic ligands (e.g., phenyl pyridine, benzoquinoline, quinolinol, bipyridyl, phenanthroline), diketone ligands (e.g., acetylacetone), carboxylic acid ligands (e.g., acetic acid ligands), carbon monooxide ligands, isonitrile ligands, and cyano ligands. More preferable ones include nitrogen-containing heterocyclic ligands. The complex may include only one transitional metal atom in the compound, or may be a multi-nuclear complex having two or more transitional metal atoms. For example, the complex may include different metal atoms simultaneously.

The phosphorescent luminescent material may be contained in the luminescent layer at a ratio of, preferably, from 0.1 weight % to 40 weight %, more preferably from 0.5 weight % to 20 weight %.

The host material that may be contained in the luminescent layer in the invention may be selected from, for example, those having carbazole skeletons, those having diarylamine skeletons, those having pyridine skeletons, those having pyrazine skeletons, those having triazine skeletons, those having arylsilane skeletons, and those mentioned in the items for the hole injection layer, the hole transport layer, the electron injection layer, and the electron transport layer described below.

The thickness of the luminescent layer is not particularly limited, and a thickness of from 1 nm to 500 nm is usually preferable. The thickness is more preferably from 5 nm to 200 nm, and still more preferably from 10 nm to 100 nm.

The luminescent material to be used for patterning by a laser transfer method in the invention is not particularly limited, and it is preferable to use a multidentate metal complex as the luminescent material from the viewpoint of preventing deterioration in luminescent characteristics due to deterioration of the material during laser transfer. As the multidentate metal complex, a known material may be used.

—Hole Injection Layer, Hole Transport Layer—

The hole injection layer or the hole transport layer is a layer having functions of receiving holes from the anode or from the anode side, and transporting the holes to the cathode side. The hole injection layer and the hole transport layer are each preferably a layer containing at least one selected from, for example, various metal complexes, and typical examples of the metal complexes include an Ir complex having a ligand such as a carbazole derivative, a triazole derivative, an oxazole derivative, an oxadiazole derivative, an imidazole derivative, a polyarylalkane derivative, a pyrazoline derivative, a pyrazolone derivative, a phenylenediamine derivative, an arylamine derivative, an amino-substituted chalcone derivative, a styrylanthracene derivative, a fluorenone derivative, a hydrazone derivative, a stilbene derivative, a silazane derivative, an aromatic tertiary amine compound, a styrylamine compound, an aromatic dimethylidine compound, a porphyrin compound, an organic silane derivative, carbon, phenylazole, or phenylazine.

The thicknesses of the hole injection layer and the hole transport layer are each preferably 500 nm or less from the viewpoint of lowering the driving voltage.

The thickness of the hole transport layer is preferably from 1 nm to 500 nm, more preferably from 5 nm to 200 nm, still more preferably from 10 nm to 200 nm. The thickness of the hole injection layer is preferably from 0.1 nm to 200 nm, more preferably from 0.5 nm to 200 nm, still more preferably 1 nm to 200 nm.

The hole injection layer and the hole transport layer each may have a monolayer structure containing one, or two or more, of the materials mentioned above, or each may have a multilayer structure having plural layers of the same composition or of different compositions.

—Electron Injection Layer, Electron Transport Layer—

The electron injection layer or the electron transport layer is a layer having functions of receiving electrons from the cathode or from the cathode side, and transporting the electrons to the anode side. The electron injection layer and the electron transport layer are each preferably a layer containing at least one of a metal complex, an organic silane derivative, and the like. The metal complex may be selected from various metal complexes, and typical examples thereof include a metal complex of a triazole derivative, an oxazole derivative, an oxadiazole derivative, an imidazole derivative, a fluorenone derivative, an anthraquinodimethane derivative, an anthrone derivatives, a diphenylquinone derivative, a thiopyran dioxide derivative, a carbodiimide derivative, a fluorenylidenemethane derivative, a distyrylpyrazine derivative, a tetracarboxylic acid anhydride having an aromatic ring such as naphthalene or perylene, a phthalocyanine derivative, or a 8-quinolinol derivative, a metal phthalocyanine, and a metal complex having a ligand such as benzoxazole or benzothiazole.

The thicknesses of the electron injection layer and the electron transport layer are each preferably 500 nm or less from the viewpoint of lowering the driving voltage.

The thickness of the electron transport layer is preferably from 1 nm to 500 nm, more preferably from 5 nm to 200 nm, still more preferably from 10 nm to 100 nm. The thickness of the electron injection layer is preferably from 0.1 nm to 200 nm, more preferably from 0.2 nm to 100 nm, still more preferably from 0.5 nm to 50 nm.

The electron injection layer and the electron transport layer each may have a monolayer structure containing one, or two or more, of the materials mentioned above, or each may have a multilayer structure having plural layers of the same composition or of different compositions.

—Hole Blocking Layer—

The hole blocking layer is a layer having a function of preventing the holes that have been transported from the anode side to the luminescent layer from passing through to the cathode side. In the present invention, the hole blocking layer may be provided as an organic compound layer that adjoins the luminescent layer at the cathode side of the luminescent layer.

Examples of organic compounds for constituting the hole blocking layer include aluminum complexes such as BAlq, triazole derivatives, and phenanthroline derivatives such as BCP.

The thickness of the hole blocking layer is preferably from 1 nm to 500 nm, more preferably from 5 nm to 200 nm, and still more preferably from 10 nm to 100 nm.

The hole blocking layer may have a monolayer structure containing one, or two or more, of the materials mentioned above, or each may have a multilayer structure having plural layers of the same composition or of different compositions.

—Formation of Organic Compound Layer—

In an organic electroluminescent element according to the invention, each of the organic compound layer(s) may be formed preferably by, for example, any of a dry-system film forming method such as a deposition method or a sputtering method, a transfer method, or a printing method.

In the organic electroluminescent element according to the invention, conventionally known means may be used as patterning methods. At least one of the organic compound layer(s) is patterned by a laser transfer method.

The laser transfer method belongs to thermal transfer methods, which are dry etching methods. The thermal transfer methods are methods of forming a pattern of an organic thin film layer by transferring an image forming substance onto a substrate by heat energy provided by conversion of light emitted from a light source. The laser transfer method includes: (1) a donor sheet preparing step of forming, on a film, at least a layer that absorbs electromagnetic wave and converts it to heat and a transfer layer thereon that includes an organic electroluminescent material; (2) a step of contacting the transfer layer surface side of the donor sheet with that surface of a substrate on which pixels are to be formed; and (3) a step of selectively irradiating the donor sheet with a laser so as to thermally melt the transfer layer and so as to transfer the organic electroluminescent material onto the substrate.

In the laser transfer method, portions to which the donor sheet is to be transferred is locally heated, and the substrate on which pixels are to be formed is not heated. Therefore, in an organic EL display element having a driving TFT and an organic EL element on a flexible substrate in particular, the laser transfer method is advantageous in that the substrate is not dimensionally altered by heat and problems such as positional inaccuracy of pixels are not caused.

Pattern forming techniques utilizing thermal transfer methods are roughly classified into techniques of controlling the light from a light source and techniques involving transfer films. As the techniques of controlling the light, a technique that generally involves scanning, in a desired pattern, the transfer film placed on the substrate with a laser beam focused to an arbitrarily-selected value has been used.

A technique has been disclosed in U.S. Pat. No. 5,521,035 in which a color filter is produced by laser-induced thermal transfer of a color material from a transfer film to an image-receiving substrate; this technique is a technique of transferring the color material to a surface of the substrate using a Nd:YAG laser.

A technique has been disclosed in U.S. Pat. No. 5,998,085 in which a light emitting material is transferred by a laser transfer method to form a pattern of the light emitting material. The laser transfer is effected by a plane scanning using a single-mode Nd:YAG laser. In Examples of the patent, the scanning is conducted by a DC galvanometer, focus is set on the image plane using a f-θlens, and a laser spot size of 140 μm×140 μm is applied at 8 W; a glass substrate is used as the image receiving substrate, and the laser irradiation is conducted under a vacuum condition with the image receiving substrate being superposed on the donor sheet; the donor sheet has a coating layer of a photothermal converting material such as carbon black, a protective intermediate layer, and a light emitting material layer in this order on a polyester film or the like; the light emitting material emits light when the glass substrate after the transfer is irradiated with UV light, whereby the pattern of the transferred light emitting material is visually observed. U.S. Pat. No. 5,998,085 does not describe or suggest patterning of an organic EL element, nor an organic EL display device having an organic EL element and a driving TFT.

JP-A No. 2003-168569 discloses a full-color organic EL display device and a method for producing the same, and discloses a technique of forming an organic thin layer of an organic EL element by a laser transfer method. This document further discloses that, when that surface of the substrate to which laser transfer is conducted is an insulating layer, the laser transfer can be effected uniformly without unevenness and edge defects of the organic thin film that occur at the interface between the insulating layer and a transparent electrode can be prevented, by making an edge portion of the insulating layer taper-shaped.

On the other hand, in the field of organic EL elements, development and research have been actively conducted on donor sheets to be used for patterning of an organic thin film layer, for forming a color filter, or for positioning a spacer. Examples of patents related to such donor sheets include U.S. Pat. Nos. 5,220,348, 5,256,506, 5,278,023, 5,308,737, 5,998,085, 6,228,555, 6,194,119, 6,140,009, 6,057,067, 6,284,425, 6,270,934, 6,190,826, and 5,981,136.

<Protective Layer>

In the present invention, the entire organic EL element may be protected with a protective layer.

The material contained in the protective layer should have a function of preventing substances that accelerates deterioration of the element, such as moisture or oxygen, from entering the element.

Specific examples of the material include metals such as In, Sn, Pb, Au, Cu, Ag, Al, Ti, and Ni, metal oxides such as MgO, SiO, SiO₂, Al₂O₃, GeO, NiO, CaO, BaO, Fe₂O₃, Y₂O₃, and TiO₂, metal nitrides such as SiNₓ and SiNₓO_{y}, metal fluorides such as MgF₂, LiF, AlF₃, and CaF₂, polyethylene, polypropylene, polymethyl methacrylate, polyimide, polyurea, polytetrafluoroethylene, polychlorotrifluoroethylene, polydichlorodifluoroethylene, copolymers of chlorotrifluoroethylene and dichlorodifluoroethylene, copolymers obtained by copolymerization of a mixture of monomers including tetrafluoroethylene and at least one comonomer, fluorine-containing copolymers each having a cyclic structure in the copolymer main chain, water absorbing substances having a water absorption coefficient of 1% or more, and dampproof substances having a water absorption coefficient of 0.1% or less.

Methods for forming the protective layer are not particularly limited, and the following methods are applicable: a vacuum deposition method, a sputtering method, a reactive sputtering method, an MBE (molecular beam epitaxy) method, a cluster ion beam method, an ion plating method, a plasma polymerization method (radio-frequency exciting ion plating method), a plasma CVD method, a laser CVD method, a heat CVD method, a gas source CVD method, a coating method, a printing method, and a transfer method.

<Sealing>

Further, an entire organic electroluminescent element according to the invention may be sealed by using a sealing container.

Further the space between the sealing container and the luminescent element may be filled with a water absorbing agent or an inactive liquid. The water absorbing agent is not particularly limited, and examples thereof include barium oxide, sodium oxide, potassium oxide, calcium oxide, sodium sulfate, calcium sulfate, magnesium sulfate, phosphorous pentaoxide, calcium chloride, magnesium chloride, copper chloride, cesium fluoride, niobium fluoride, calcium bromide, vanadium bromide, molecular sieve, zeolite, and magnesium oxide. The inactive liquid is not particularly limited, and examples thereof include paraffins, liquid paraffins, fluorine-containing solvents such as perfluoroalkanes, perfluoroamines, and perfluoroethers, chlorine-containing solvents, and silicone oils.

An organic electroluminescent element according to the invention emits light when a DC voltage (usually from 2 to 15 volts and optionally containing an AC component as required) or a DC current is applied between the anode and the cathode.

Regarding methods for driving an organic electroluminescent element according to the invention, the driving methods described in, for example, JP-A Nos. 2-148687, 6-301355, 5-29080, 7-134558, 8-234685, and 8-241047, Japanese Patent No. 2784615, and U.S. Pat. Nos. 5,828,429 and 6,023,308 may be applied.

### 3. Structure of Organic EL Display Device

An organic EL display device according to the invention is an organic EL display device including at least an organic electroluminescent element and a driving TFT that supplies an electric current to the organic electroluminescent element.

Each of the substrate of the organic electroluminescent element and the substrate of the driving TFT in the invention is preferably a flexible resin substrate, and it is more preferable that the organic electroluminescent element and the driving TFT are disposed on the same substrate.

In a preferable exemplary embodiment, the drain electrode of the driving TFT and an electrode (e.g., the anode) of the organic EL element are made of the same material and are produced by the same process. Preferably, the drain electrode and the anode of the organic EL element include indium tin oxide.

It is preferable to provide an insulating film on the peripheral portion of a pixel electrode of the organic EL element. It is more preferable that this insulating film and the insulating film of the driving TFT are made of the same material and are produced by the same method.

Accordingly, in the invention, a part of the constituent materials of the organic electroluminescent element and a part of the constituent materials of the driving TFT are preferably made of the same material and are preferably produced by the same method, whereby the production process can be made simpler, defects such as short circuits caused by deficiency in connection of the electrodes are reduced, and an insulating film can be formed uniformly with sufficient insulating performance.

In the following, the structure and the production process of an organic EL display device according to the invention will be described by reference to figures.

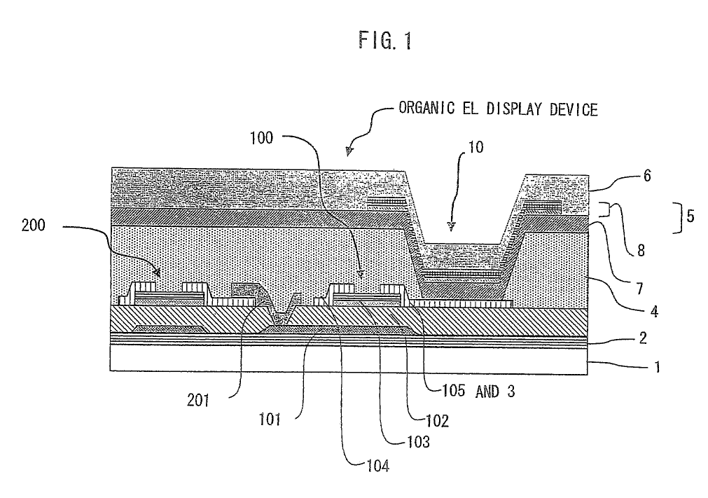

FIG. 1 is a conceptual diagram showing structures of a driving TFT 100 and an organic EL element 10 of the organic EL display device according to the invention. A substrate 1 is a flexible support, and is a plastic film such as PEN. The substrate 1 has a substrate insulating layer 2 on a surface thereof so as to possess an insulating property. A gate electrode 101 is provided thereon in the driving TFT portion 100 and a switching TFT portion 200. A gate insulating film 102 is further provided on the whole of the TFT and the organic EL element, and a connection hole is provided in a part of the gate insulating film 102 so as to allow electrical connection. An active layer-resistive layer 103 according to the invention is provided in the driving TFT portion and the switching TFT portion, and a source electrode 104 and a drain electrode 105 are provided thereon. The drain electrode 105 and a pixel electrode (anode) 3 of the organic EL element 10 are continuous and integrated, and made of the same material and produced by the same process. The drain electrode of the switching TFT 200 and the driving TFT 100 are electrically connected at the connection hole by a connection electrode 201. Further, the entire surface, excluding that portion of the pixel electrode at which the organic EL element is to be provided, is covered with an insulating film 4. On the pixel electrode portion, organic layers 5 including a luminescent layer and a cathode 6 are provided so as to form the organic EL element 10. In the invention, at least one of the organic layers 5 is patterned by a laser transfer method. In a preferable exemplary embodiment, one or more organic layers including at least the luminescent layer are patterned by a laser transfer method. In the structure illustrated in FIG. 1, a hole injection layer 7 is not patterned, and organic layers including a hole transport layer, the luminescent layer, an electron transport layer, and an electron injection layer provided in this order on the hole injection layer 7 are patterned by a laser transfer method.

Although not shown in the figure, it is also a preferable exemplary embodiment of the present invention to use a top-gate type TFT as the driving TFT in FIG. 1.

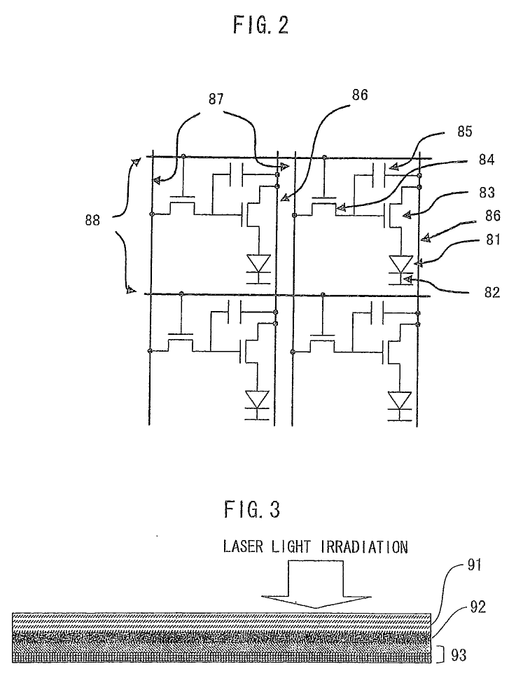

FIG. 2 is a schematic circuit diagram of main portions of a switching TFT, a driving TFT, and an organic EL element in an organic EL display device according to the invention, wherein in FIG. 2, 81 represents organic EL element, 82 represents cathode, 83 represents driving TFT, 84 represents switching TFT, 85 represents condenser, 86 represents common electric wires, 87 represents signal electric wires and 88 represents scanning electric wires. The circuit of the organic EL display device in the invention is not particularly limited to that shown in FIG. 2, and conventionally known circuits may be applied as they are.

FIG. 3 shows an example of a structure of a donor sheet to be used in a laser transfer method. A flexible transparent film 91 has, on one surface thereof, a photothermal converting layer 92 and a transfer layer 93. Although not shown in the figure, an intermediate layer may be provided between the photothermal converting layer 92 and the transfer layer 93. The transfer layer 93 may have only a single layer, or may have plural layers. In particular, when patterns for patterning are the same, a method is preferable from the viewpoint of productivity due to decrease in the number of transfer steps, the method including stacking, in layers, the organic materials to be transferred to form coating layers on a donor sheet, and transferring the coating layers. Laser light is irradiated from the side of the donor sheet that is opposite to the side at which the transfer layer is provided, the photothermal converting layer 92 absorbs the laser light, converts it to heat, and thus increases the temperature of the transfer layer, whereby the softened transfer layer is transferred to the substrate that is in contact with the transfer layer. It is possible to provide an intermediate layer between the photothermal converting layer 92 and the transfer layer 93, so as to allow easy peeling of transfer layer 93 off the photothermal converting layer 92 and so as to ease the transfer.

(Applications)

Organic EL display devices according to the invention may be applied to a wide range of fields, including cell phone displays, personal digital assistants (PDA), computer displays, information displays to be mounted on automobiles, TV monitors, and general illumination.

The disclosure of Japanese Patent Application No. 2007-99516 is incorporated hereby reference in its entirety.

### EXAMPLES

In the following, the organic EL display device according to the invention is described by reference to Examples. However, the Examples should not be construed as limiting the invention.

### Example 1

### 1. Production of Organic EL Display Device

An organic EL display device 1 having a structure shown in FIG. 1 was produced.

### 1) Formation of Substrate Insulating Film

On a 5 inch×5 inch film of polyethylene naphthalate (simply referred to as PEN), SiON was deposited to a thickness of 500 nm by sputtering, thereby forming a substrate insulating film.

Sputtering condition: Sputtering was conducted by using an RF magnetron sputtering apparatus at an RF power of 400 W and a sputtering gas flow rate of Ar/O₂=12.0/3.0 sccm. The target was Si₃N₄.

### 2) Formation of Gate Electrode (and Scanning Electric Wires)

After the substrate was washed, Mo was deposited to a thickness of 100 nm by sputtering. Then a photoresist was applied, a photomask was superposed thereon, and the photoresist was exposed through the photomask. Unexposed portions were cured by heating, and uncured photoresist was removed by a subsequent treatment with an alkaline developer. Thereafter treatment with an etching liquid was conducted to dissolve and remove that portion of the electrode region that was not covered with the cured photoresist. Finally, the photoresist was peeled off, thereby finishing the patterning process. As a result, a patterned gate electrode and patterned scanning electric wires were provided.

The treatment conditions at respective steps were as follows:

Sputtering condition for Mo: Sputtering was conducted by using a DC magnetron sputtering apparatus at a DC power of 380 W and a sputtering gas flow rate of Ar=12 sccm.

Photoresist coating condition: Photoresist OFPR-800 (manufactured by Tokyo Ohka Kogyo Co., Ltd.) was applied by spin coating at 4000 rpm for 50 sec.

Prebaking condition: 80° C., 20 min.

Exposure condition: 5 sec. (the g line of a ultra-high pressure mercury lamp, corresponding to 100 mJ/cm²)

Developing condition:
Developer NMD-3 (manufactured by Tokyo Ohka Kogyo Co., Ltd.): 30 sec. (immersion)+30 sec. (agitation)
Rinsing: two cycles of (ultrasonic rinsing with pure water for 1 min.)
Postbaking: 120° C. for 30 min.
Etching condition:
   etching liquid was a mixed acid of nitric acid/phosphoric acid/acetic acid
Resist peeling condition: two cycles of (immersion in peeling liquid 104 (manufactured by Tokyo Ohka Kogyo Co., Ltd.) for 5 min.)
Washing: two cycles of (washing with IPA ultrasonic wave for 5 min.), and ultrasonic washing with water for 5 min.
Drying: blowing with N₂, and baking at 120° C. for 1 hour.

### 3) Formation of Gate Insulating Film

Subsequently, SiO₂ was sputtered to form a gate insulating film having a thickness of 200 nm.

Sputtering condition: sputtering was conducted by using an RF magnetron sputtering apparatus at an RF power of 400 W and a sputtering gas flow rate of Ar/O₂=12.0/2.0 sccm.

### 4) Formation of Active Layer and Resistive Layer

On the gate insulating film, a 10 nm-thick IGZO film (active layer) having a higher electrical conductivity and a 40 nm-thick IGZO film (resistive layer) having a lower electrical conductivity were sequentially provided by sputtering. Then patterning by a photoresist method was conducted to form an active layer and a resistive layer.

The sputtering conditions for the IGZO film having a higher electrical conductivity and the IGZO film having a lower electrical conductivity were as follows:

Sputtering conditions for the IGZO film having a higher electrical conductivity: sputtering was conducted on a polycrystalline sintered body having a composition of InGaZnO₄ as the target, by using an RF magnetron sputtering apparatus at a DC power of 200 W and a sputtering gas flow rate of Ar/O₂=12.0/0.6 sccm.

Sputtering conditions for the IGZO film having a lower electrical conductivity: sputtering was conducted on a polycrystalline sintered body having a composition of InGaZnO₄ as the target, by using an RF magnetron sputtering apparatus at a DC power of 200 W and a sputtering gas flow rate of Ar/O₂=12.0/1.6 sccm.

The patterning process by a photoresist method was the same as that employed for patterning the gate electrode, except that hydrochloric acid was used as the etching liquid.

### 5) Formation of Source and Drain Electrodes and Pixel Electrode

After the formation of the active layer and the resistive layer, indium tin oxide (simply referred to as ITO) was sputtered to form a film having a thickness of 40 nm. Subsequently, a patterning process was conducted by a photoresist method similar to that employed for patterning the gate electrode, so that source and drain electrodes and a pixel electrode were provided.

ITO sputtering condition: sputtering was conducted by using an RF magnetron sputtering apparatus at a DC power of 40 W and a sputtering gas flow rate of Ar=12.0 sccm.

The patterning process by a photoresist method was the same as that employed for patterning the gate electrode, except that oxalic acid was used as the etching liquid.

### 6) Formation of Contact Hole

Subsequently, a patterning process by a photoresist method was conducted in a manner similar to that employed for patterning the gate electrode. Portions other than the portion at which a contact hole was to be formed were protected with a photoresist, and a hole was made in the gate insulating film by using a buffered hydrofluoric acid as the etching liquid, so that the gate electrode was exposed. Then the photoresist was removed in a manner similar to that employed for patterning the gate electrode, whereby a contact hole was formed.

### 7) Formation of Connection Electrode (and Common Electric Wires and Signal Electric Wires)

Subsequently, Mo was sputtered to form a film having a thickness of 200 nm

sputtering condition for Mo: the same as the sputtering condition for the gate electrode forming step

Then a patterning process by a photoresist method was conducted in a manner similar to that employed for patterning the gate electrode, so that a connection electrode and common electric wires and signal electric wires were provided.

### 8) Formation of Insulating Film

Subsequently, a 2 μm-thick photosensitive polyimide film was applied, and patterned by a photoresist method to form an insulating film.

The coating and patterning conditions were as follows:

Coating condition: spin coating at 1000 rpm for 30 sec.

Exposure condition: 20 sec. (using the g line of a ultra-high pressure mercury lamp, at an energy corresponding to 400 mJ/cm²)

Developing condition:
Developer: NMD-3 (manufactured by Tokyo Ohka Kogyo Co., Ltd.) 1 min. (immersion)+1 min. (agitation)
Rinsing: ultrasonic washing with water, 1 min.×2+5 min.×1+blow with N₂
Postbaking: 120° C. for 1 hour.

Through the processes described above, a TFT substrate of an organic EL display device was produced.

### 9) Production of Organic EL Element

<Hole Injection Layer>

On a TFT substrate which had been subjected to an oxygen plasma treatment, 4,4′,4″-tris(2-naphthylphenylamino)triphenylamine (simply referred to as 2-TNATA) was deposited to a thickness of 140 nm by a resistance heating vacuum deposition.

The oxygen plasma condition was as follows:

Oxygen plasma condition: O₂ flow rate=10 sccm, RF power=200 W, treatment time=1 min.

<Hole Transport Layer, Luminescent Layer, Hole Blocking Layer, Electron Transport Layer, and Electron Injection Layer>

These layers were provided by a laser transfer method as described below.

### <Preparation of Donor Sheet>

On a polyester film having a thickness of 100 μm, carbon black in a water dispersion was applied and dried to form a photothermal converting layer having a transmission density of about 1.2. The following intermediate layer was further applied thereto.

Composition of intermediate layer: a solution of 45.0 weight % NEORAD NR-440 (manufactured by Zeneca Resins)/0.90 weight % DURACURE 1173 (manufactured by Ciba-Geigy)/54.1 weight % water

The following layers were sequentially provided on the intermediate layer by a resistance heating vacuum deposition method.

Electron injection layer: LiF, in a thickness of 1 nm

Electron transport layer: tris(8-hydroxyquinolinato) aluminum (simply referred to as Alq3), in a thickness of 20 nm

Hole blocking layer: bis-(2-methyl-8-quinonylphenolate)aluminum (simply referred to as BAlq), in a thickness of 10 nm

Luminescent layer: a layer containing CBP and a platinum complex B in an amount of 5 weight % relative to CBP, in a thickness of 20 nm

Hole transport layer: N,N′-dinaphthyl-N,N′-diphenyl-[1,1′-biphenyl]-4,4′-diamine (simply referred to as α-NPD), in a thickness of 10 nm

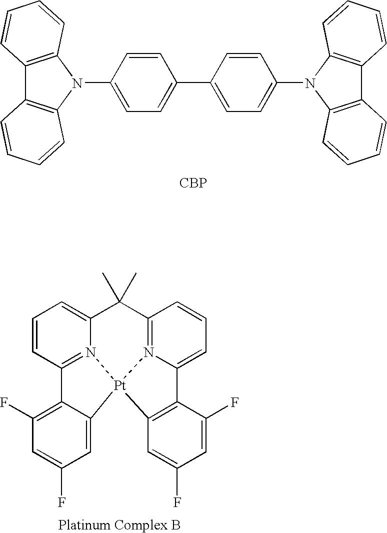

<Transfer>

The obtained donor sheet and the organic EL element were attached to each other such that the transfer layer surface of the donor sheet and the hole injection layer surface of the organic EL element contacted each other. This laminated body was irradiated with a laser through the polyester film of the donor sheet under a vacuum condition.

The laser irradiation instrument was a plane scanning instrument using a single-mode Nd:YAG laser. Exposure was conducted with a laser sport size of 140 μm×140 μm, to form pixels of 200 ppi.

<Formation of Cathode>

A 200 nm-thick cathode was provided by a resistance heating vacuum deposition method.

### 10) Sealing Process

On the TFT substrate having the organic EL element, a 2 μm-thick SiNₓ film as a sealing film was provided by plasma CVD (PECVD). Further, a protective film (PEN film having 50 nm-thick SiON deposited thereon) was adhered (90° C., 3 hours) onto the sealing film by using a thermosetting epoxy resin adhesive.

### 2. Performance of Organic EL Display Device

The organic EL display device produced by the processes described above exhibited an excellent emission surface state with no emission unevenness, when allowed to emit light at a luminance of 300 cd/m².

### Example 2

An organic EL display device 2 was prepared in the same manner as in Example 1, except that the TFT was changed to a top-gate type TFT shown in FIG. 5.

The organic EL display device 2 was evaluated in the same manner as in Example 1, and it was found that an excellent emission surface state was obtained without emission unevenness, as in Example 1.

1. An organic electroluminescent display device comprising at least a driving thin film transistor and pixels which are formed by organic electroluminescent elements and are provided in a pattern on a substrate of the TFT,
wherein the driving TFT includes at least a substrate, a gate electrode, a gate insulating film, an active layer, a source electrode, and a drain electrode; the driving TFT further includes a resistive layer between the active layer and at least one of the source electrode and the drain electrode; and the pixels are formed in a pattern by a laser transfer method.

2. The organic electroluminescent display device according to claim 1, wherein the resistive layer has a lower electrical conductivity than that of the active layer.

3. The organic electroluminescent display device according to claim 1, wherein the active layer is in contact with the gate insulating film, and the resistive layer is in contact with at least one of the source electrode and the drain electrode.

4. The organic electroluminescent display device according to claim 1, wherein the thickness of the resistive layer is greater than the thickness of the active layer.

5. The organic electroluminescent display device according to claim 1, wherein electrical conductivity continuously varies between the resistive layer and the active layer.

6. The organic electroluminescent display device according to claim 1, wherein the active layer and the resistive layer include oxide semiconductors, which may be the same or different.

7. The organic electroluminescent display device according to claim 6, wherein the oxide semiconductor is an amorphous oxide semiconductor.

8. The organic electroluminescent display device according to claim 6, wherein the oxygen concentration in the active layer is lower than the oxygen concentration in the resistive layer.

9. The organic electroluminescent display device according to claim 6, wherein the oxide semiconductor is at least one oxide selected from the group consisting of In, Ga, and Zn, or a composite oxide thereof.

10. The organic electroluminescent display device according to claim 9, wherein the oxide semiconductor includes In and Zn, and the composition ratio of Zn to In in the resistive layer is higher than that in the active layer.

11. The organic electroluminescent display device according to claim 1, wherein the electrical conductivity of the active layer is 10⁻⁴Scm⁻¹ or more but less than 10² Scm⁻¹.

12. The organic electroluminescent display device according to claim 1, wherein the ratio of the electrical conductivity of the active layer to the electrical conductivity of the resistive layer is from 10² to 10⁸.

13. The organic electroluminescent display device according to claim 1, wherein the substrate is a flexible resin substrate.

14. The organic electroluminescent display device according to claim 1, wherein the pixels have a definition of 200 ppi or more.

15. An organic electroluminescent display device patterning method of patterning pixels formed by organic electroluminescent elements on a substrate of a driving transistor, the method comprising:
forming a donor sheet containing at least a layer that absorbs an electromagnetic wave and converts it to heat, and forming a transfer layer containing an organic electroluminescent material on the donor sheet;
bringing the transfer layer side of the donor sheet into contact with a pixel-forming surface of the substrate; and
selectively irradiating the donor sheet with a laser so as to thermally melt the transfer layer and so as to transfer the organic electroluminescent material onto the substrate,
wherein the driving TFT includes at least a substrate, a gate electrode, a gate insulating film, an active layer, a source electrode, and a drain electrode; the driving TFT further includes a resistive layer between the active layer and at least one of the source electrode and the drain electrode.

16. The organic electroluminescent display device patterning method according to claim 15, wherein the pixels have a definition of 200 ppi or more.
